(19) United States
(12) Patent Application Publication
(10) Pub. No.: US 2023/0242757 A1
(43) Pub. Date: Aug. 3, 2023

(54) MELT DISPERSION PROCESS FOR MAKING POLYMER POLYOLS

(71) Applicant: Dow Global Technologies LLC, Midland, MI (US)

(72) Inventors: Sven Claessens, Lokeren (BE); Kathleen Barnes, Midland, MI (US); Stephanie A. Bloxom, Beaverton, MI (US); Niek Thomaes, Biervliet (NL); Antoon De Smet, Oostburg (NL); Nicholas B. Schaffer, Midland, MI (US)

(21) Appl. No.: 18/013,626

(22) PCT Filed: Jul. 7, 2021
(86) PCT No.: PCT/US2021/040639

§ 371 Date: Dec. 29, 2022

Related U.S. Application Data
(60) Provisional application No. 63/049,143, filed on Jul. 8, 2020.

(51) Int. Cl. C08L 71/02; C08G 65/26

(52) U.S. Cl. CPC C08L 71/02; C08G 65/2609

(57) ABSTRACT

A preformed thermoplastic polymer is dispersed into a polyol via a mechanical dispersion process. A stabilizer is present to stabilize the dispersed polymer particles. An antisolvent is also present. The antisolvent has been found to lead to smaller particle size and increased dispersion stability.

This invention relates to methods for making dispersions of polymer particles in a polyol.

So called “polymer polyols” are well known materials. They have a continuous liquid phase made up of one or more compounds having multiple hydroxyl groups. Solid particles of another polymer are dispersed in the polyol phase. Common dispersed phase particles are styrene polymers and copolymers (including styrene-acrylonitrile polymers), polyurea polymers and polyurethane-urea polymers, among others.

Historically, polymer polyols have been manufactured primarily by polymerizing the disperse phase polymer directly within the continuous polyol phase. However, this process has certain disadvantages, which potentially can be overcome using a mechanical dispersion process such as is described in U.S. Pat. No. 6,613,827. In the mechanical dispersion process, the discontinuous phase polymer is formed separately and then dispersed into the polyol. The dispersion step can be performed by heat-softening the previously-formed polymer followed by blending the heat-softened polymer with the polyol under shear. The shearing action breaks the heat-softened polymer into small droplets which become dispersed in the polyol phase. Upon cooling, a dispersion of polymer particles is formed.

A shortcoming of the mechanical dispersion process is that a desired combination of high solids (i.e., a high content of the dispersed polymer particles) and low viscosity has proven difficult to attain. At equivalent solids levels, polymer polyols made using a mechanical dispersion process tend to have significantly higher viscosities than those made using in situ polymerization methods. The problem is particularly acute with high solids products containing greater than 35% by weight dispersed solids.

Therefore, it would be desirable to provide a more useful mechanical dispersion method for making polymer polyols, especially a method by which lower product viscosities can be obtained even at high solids.

This invention is a such method for making a polymer polyol. The method comprises comprising the steps of:

(a) forming a heated and pressurized mixture of i) one or more 250 to 6000 hydroxyl equivalent weight alcohols selected from the group consisting of polyethers having an an oxyalkylene content of at least 80% by weight, polyesters and natural oil polyols, each alcohol nominally having 1 to 8 hydroxyl groups per molecule, wherein each such alcohol is a liquid at 25° C. and 101.3 kPa atmospheric pressure and has a boiling temperature of at least 150° C. at 101.3 kPa atmospheric pressure; ii) a thermoplastic polymer that is insoluble in component i) and has a Vicat softening temperature of greater than 60° C. and up to 300° C., iii) a dispersion stabilizer and iv) an antisolvent, the heated and pressurized mixture being at a temperature above the Vicat softening temperature of the thermoplastic polymer and at a pressure sufficient to maintain the antisolvent and component i) as a liquid.

(b) shearing the heated and pressurized mixture to form a dispersion of droplets of the heat-softened thermoplastic polymer in a liquid phase that includes the 250 to 6000 hydroxyl equivalent weight alcohol or alcohols and

(c) cooling the dispersion of droplets to below the Vicat softening temperature of the thermoplastic polymer to solidify the droplets of the thermoplastic polymer to form particles thereof and form the polymer polyol.

The presence of the antisolvent has been found to lead to reduced dispersed particle size and reduced viscosity in the product after the antisolvent has been removed. The reduced viscosities are seen even at high solids levels of 35% by weight or more. Accordingly, the invention provides a simple and inexpensive route to achieving the goals of high solids and reduced product viscosity. In addition, the antisolvent is easily removed from the product.

Component i) is one or more alcohols each having a hydroxyl equivalent weight of 250 to 6000 and nominally 1 to 8 hydroxyl groups per molecule. Each such alcohol is selected from polyethers having an oxyalkylene content of at least 80%, polyesters and natural oil polyols. Each alcohol in component i) is a liquid at room temperature and 101.3 kPa atmospheric pressure and has a boiling temperature of at least 150° C. at 101.3 kPa atmospheric pressure.

Suitable polyethers are prepared by alkoxylating an initiator compound having one or more active hydrogen atoms. The nominal number of hydroxyl groups per molecule corresponds to the number average number of active hydrogen atoms on the initiator or initiators used to prepare the polyether. The active hydrogens are generally present as hydroxyl, primary amino, secondary amino or thiol groups. A primary amino group contains two active hydrogen atoms. The initiator preferably is one or more hydroxyl-containing compounds.

The polyethers of component i) contain at least 80%, preferably at least 90%, by weight of oxyalkylene units. The weight of oxyalkylene units can be determined by proton NMR, or alternatively calculated from the weights of starting materials polymerized to produce each polyether. In some embodiments, the entire weight of each polyether is constituted by oxyalkylene units and a residue, after removal of active hydrogen atoms, of the initator(s).

The polyethers of component i) in some embodiments have a hydroxyl equivalent weight of at least 350, at least 450, at least 750 or at least 1000 and in specific embodiments may be up to 4000, up to 3000, up to 2500, up to 2200 or up to 2000.

Examples of the component i) polyethers include, for example, polymers of propylene oxide, ethylene oxide, 1,2-butylene oxide, tetramethylene oxide, block and/or random copolymers thereof, and the like. Of particular interest are random and/or block copolymers of propylene oxide and ethylene oxide that contain 1 to 50% by weight oxyethylene units. In some embodiments, such a copolymer may contain at least 5% or at least 7% by weight oxyethylene units and in some embodiments may contain up to 35%, up to 25% or up to 20% by weight oxyethylene units. In some embodiments, the copolymer is an ethylene oxide-capped poly(propylene oxide) or an ethylene oxide-capped random copolymer of propylene oxide and ethylene oxide, in each case having an oxyethylene content as described in the preceding sentence.

The polyether may contain low levels of terminal unsaturation (for example, less than 0.02 meq/g or less than 0.01 meq/g). Examples of such low unsaturation polyethers include those made using so-called double metal cyanide (DMC) catalysts, as described for example in U.S. Pat. Nos. 3,278,457, 3,278,458, 3,278,459, 3,404,109, 3,427,256, 3,427,334, 3,427,335, 5,470,813 and 5,627,120.

Alternatively, some or all of the polyether may contain terminal unsaturation. Such terminal unsaturation may include propenyl and/or allylic unsaturation that is produced in a side-reaction when the polyether is manufactured. Some or all of the terminal unsaturation may be produced by capping the polyether with one or more ethylenically unsaturated capping groups. Ethylenically unsaturated isocyanates, ethylenically unsaturated siloxanes, ethylenically unsaturated carboxylic acids and ethylenically unsaturated epoxides are suitable capping agents. Specific capping agents include isocyanatoethylmethacrylate, isopropenyl dimethylbenzyl isocyanate (including in particular m-isopropenyl-α,α-dimethylbenzyl isocyanate) and vinyltrimethoxysilane.

Natural oil polyols useful as all or part of component i) include hydroxyl-2 functional triglycerides such as oils and fats produced in biological processes by plants and/or animals. Castor oil is an example of such a triglyceride. The hydroxyl-functional triglycerides also include various oils and fats that have been modified, typically by oxidation or hydrolysis of one or more carbon-carbon double bonds, to introduce hydroxyl groups. Examples of the latter type of hydroxyl-functional triglycerides include the so-called “blown” soybean oils, which have been oxidized or hydrolyzed to introduce hydroxyl groups, such as are described in US Published Patent Applications 2002/0121328, 2002/0119321 and 2002/0090488.

Component ii) is a thermoplastic polymer characterized in that is insoluble in component i) and has a Vicat softening temperature of greater than 60° C. and up to 300° C. The thermoplastic polymer may be semi-crystalline, in which case it preferably also preferably has a crystalline melting temperature in the range of greater than 60° C. and up to 300° C. The thermoplastic polymer may instead be non-crystalline, in which case it exhibits a softening temperature as set forth above but no crystalline melting temperature.

Vicat softening temperature is conveniently determined according to ASTM D1525-17e1 under a 10 newton load and a heating rate of 120° K per hour. In some embodiments, the thermoplastic polymer has a Vicat softening temperature of at least 75° C. or at least 85° C. and up to 275° C., up to 250° C., up to 225° C., up to 200° C., up to 175° C. or up to 150° C.

The thermoplastic polymer is insoluble in component i). For purposes of this invention, the thermoplastic polymer is considered to be insoluble in component i) if soluble therein to the extent of no more than 2% (i.e., 2 grams of thermoplastic polymer in 100 grams of component i). The solubility is more preferably no greater than 1% and even more preferably no more than 0.5%.

Solubility in component i) is conveniently determined by forming a mixture of equal parts by weight of components i) and ii) (in the absence of a stabilizer), heating the mixture to above the Vicat softening temperature of component ii) with agitation for one hour to break the thermoplastic polymer into droplets dispersed in component i), and then cooling the mixture to room temperature. Insolubility is indicated by settling of the particles in the cooled mixture, as seen by the naked eye. The solubility can be determined from the weight of the settled particles.

The component ii) thermoplastic polymer preferably contains no more than 0.25% by weight, preferably no more than 0.05% by weight, hydroxyl, thiol, primary amino and secondary amino group combined, and may be devoid of such groups. The component ii) thermoplastic polymer preferably is unreactive toward isocyanate groups.

Examples of component ii) thermoplastic polymers include poly(vinyl aromatic) polymers such as polystyrene; copolymers of one or more vinyl aromatic monomers with one or more other monomers, such as a styrene-acrylonitrile copolymer, a styrene-butadiene copolymer, a styrene-butyl acrylate copolymer, a styrene-methyl methacrylate copolymer, a styrene-vinyl acetate copolymer or an acrylonitrile-butadiene-styrene copolymer; polymers of conjugated dienes such as polymers and copolymers of butadiene; polyolefins such as polyethylene, ethylene-higher alkene copolymers and polypropylene; polyesters, polylactic acid, polycarbonates, thermoplastic polyurethanes and polyamides. Polystyrene and styrene-acrylonitrile copolymers are preferred.

The molecular weight of the thermoplastic polymer is not especially critical, provided that the polymer has the desired softening temperature, and that the softened polymer has a viscosity, at a temperature suitable for making the polymer polyol, that permits the polymer to be dispersed into droplets 100 microns or smaller in diameter, as measured by light diffraction methods. The thermoplastic polymer suitably has a melt flow index of from 1 to 20 decigrams/minute, when measured according to ASTM D-1238 at 200° C. under a 5 kg applied load.

Component iii) a dispersion stabilizer. The stabilizer is one or more materials, different from components i), ii) and iv), that function in the process and in the product to reduce or eliminate settling of the dispersed thermoplastic polymer from the liquid component i) phase. In some embodiments, such stabilizer has a molecular structure that includes at least one segment compatible with the liquid component i) phase and at least segment compatible with the thermoplastic polymer. Suitable stabilizers include, for example;

a) an imide-containing reaction product of a maleic anhydride-functionalized polyethylene wax with a monoamine polyol as described, for example, in U.S. Pat. No.

) a reaction product of ethylene-acrylic acid copolymer with a monoamine polyol as described, for example, in U.S. Pat. No. 6,613,827;

c) polyester-polyether block copolymers, polyamide-polyether block copolymers, polystyrene-polyether block copolymers, and polyethylene-polyether block copolymers, as described, for example, in U.S. Pat. No. 8,344,061; and

d) copolymers of (1) a polyether polyol having polymerizable carbon-carbon unsaturation with (2) styrene or a mixture of styrene and one or more other ethylenically unsaturated monomers having a molecular weight of 150 or less and which are copolymerizable with styrene. The polyether polyol may be a branched polyol having a number average molecular weight (by GPC against a polyether standard) of 4000 to 2000, 0.2 to 1.2 polymerizable ethylenically unsaturated groups per molecule and 3 to 8 hydroxyl groups per molecule. Such copolymers are described, for example, in U.S. Pat. Nos. 8,822,581, 9,994,701, US Published Patent Application No. 2017-0044297 and US Published Patent Application No. 2017-0051097. They may have linear, branched, comb, star or other structures.

The stabilizer in some embodiments comprises a copolymer of (1) from 10 to 70% by weight of a branched polyol having a number average molecular weight of from 4000 to 20,000, at least 1 polymerizable ethylenically unsaturated group per molecule and from about 3 to about 8 hydroxyl groups per molecule with (2) from 30 to 90% by weight of styrene or a mixture of styrene and one or more other low molecular weight monomers. The copolymer preferably is a copolymer of from 10 to 40% by weight of (1) and 60 to 90% by weight of (2). More preferably, it is a copolymer of from 15 to 35%, by weight of (1) and 65 to 85% by weight of (2). “Low molecular weight” monomers have a molecular weight of no greater than 150 g/mol. A copolymer as described in this paragraph suitably has a number average molecular weight of from about 20,000 g/mol to about 300,000 g/mol, as measured by GPC against a polystyrene standard. Such copolymers and methods for making them are described, for example, in U.S. Pat. Nos. 8,822,581 and 9,994,701.

The dispersion stabilizer may be provided as a mixture of the stabilizer in one or more carriers. The carrier may constitute up to about 80%, preferably from about 20 to 80% and more preferably from about 50 to 80%, of the combined weight of the carrier and the stabilizer. The carrier material is some embodiments may include one or more polyethers as described with respect to component i); if such polyethers are present as carriers, the weight thereof is counted as part of the weight of component i). Such polyether carriers may include, for example, an unreacted quantity of a starting polyether used in making the dispersion stabilizer.

The carrier material also may include an antisolvent as described with respect to component d), in which case that portion of the carrier material is counted toward the weight of component d).

The carrier material also may be a monol or polyol different from components i) and iv). Such a monol or polyol may have a hydroxyl equivalent weight of, for example, 75 to 249 or more, and may have from 1 to 8 or more hydroxyl groups per molecule. Such a monol or polyol carrier preferably is a liquid at 25° C. and 101.3 kPa atmospheric pressure and has a boiling temperature of at least 150° C. at 101.3 kPa atmospheric pressure. The antisolvent is a liquid at 25° C. and 101.3 kPa atmospheric pressure. It has a boiling temperature of less than 150° C., preferably 60 to 125° C. or 75 to 120° C., at 101.3 kPa atmospheric pressure. The thermoplastic polymer is soluble in the antisolvent to the extent of no more than 2 parts by weight thermoplastic polymer per 100 parts by weight antisolvent. The antisolvent in some embodiments has a formula molecular weight of no greater than 125 or no greater than 75.

The antisolvent in some embodiments is water and/or one or more organic compounds that are soluble in water to the extent of at least 5 parts by weight, preferably at least 25 parts by weight, per 100 parts by weight water. An organic antisolvent may be, for example, a C1-C4 alcohol such as ethanol, 1-propanol, 2-propanol, 1-butanol, 2-butanol, t-butanol and isobutanol. Other useful organic antisolvents include acetone, methylethyl ketone, acetonitrile, 1,4-dioxane, pyridine and tetrahydrofuran. 2-propanol is a preferred antisolvent. Water is most preferred.

The polymer polyol is produced in a process that includes a step of forming a heated and pressurized mixture of components i), ii), iii) and iv). The temperature of the mixture is above the Vicat softening temperature of the thermoplastic polymer. The temperature of the mixture may be, for example, at least 100° C., at least 125° C., at least 150° C. or at least 175° C. and up to 250° C. or up to 225° C., provided that it is above the Vicat softening temperature. The pressure is sufficient to maintain component i) and the antisolvent (component iv)) as a liquid at the temperature employed. The pressure may be, for example, at least 0.25 MPa, at least 0.5 MPa, at least 1 MPa and up to 50 MPa up to 25 MPa, up to 10 MPa or up to 5 MPa.

The heating and pressurized mixture in some embodiments contains components i)-iv) in the following weight percentages, in all cases being based on the combined weights of components i)-iv):

a) at least 35 wt.-%, at least 45 wt.-% or at least 50 wt-% and up to 90 wt.-%, up to 80 wt.-%, up to 70 wt.-% or up to 60 wt.-% of component i);

b) at least 5 wt.-%, at least 10 wt.-%, at least 25 wt.% and up to 50 wt.%, up to 40 wt.-% or up to 35 wt-% component ii);

c) at least 0.5 wt.-%, at least 1 wt.-%, at least 1.5 wt.% or at least 2 wt.-% and up to 10 wt.-%, up to 7.5 wt.-% or up to 5 wt.-% of component iii); and

d) at least at least 0.5 wt.-%, at least 1 wt.-%, at least 2 wt.-% or at least 2.5 wt.-% and up to 20 wt.-%, up to 10 wt.-% or up to 7.5 wt.-% of component iv).

The heated and pressurized mixture is subjected to shear to form a dispersion of droplets of the heat-softened thermoplastic polymer in a liquid phase that includes the component i). The temperature and pressure conditions in this step are as in the previous one; i.e., above the Vicat softening temperature of the thermoplastic resin and at a pressure sufficient to keep components i) and iv) as liquids. Shearing is continued until the droplets have attained a desired size. It is generally preferred to produce droplets having a volume average particle size of no greater than 100 μm, especially no greater than 50 μm, no greater than 25 μm or no greater than 15 μm as measured by laser diffraction. The volume average particle size may be at least 100 nm, at least 500 nm, at least 1 μm or at least 2.5 μm.

Once the droplets have been formed and sheared to the desired size, the dispersion of droplets is cooled to below the Vicat softening temperature of the thermoplastic polymer. The dispersion preferably is agitated during this step to minimize coalesce of the dispersed droplets. The droplets solidify upon cooling to form particles, thereby producing the polymer polyol.

Suitable apparatus and methods for making the polymer polyol are described, for example, in U.S. Pat. No. 6,613,827. The apparatus can be any device or series of devices in which the heated and pressurized mixture can be formed, sheared into droplets in the presence of the polyol and then maintained under agitation or shear until the dispersed droplets can be cooled and solidified.

Examples of suitable apparatus include high shear batch mixers such as a Brabender mixer or a Parr reactor; a rotor stator or; preferably, an extruder. Two or more of these apparatuses can be used in combination, such as tandem extruders, or an extruder coupled to a rotor stator. By “extruder”, it is meant a device having an elongated barrel, an outlet at or near one end of the barrel, mixing elements within the elongated barrel, and a means for pushing a liquid or molten material as essentially a plug flow through the mixing elements, to and out of the outlet. Most typically, the extruder will have one or more longitudinal, rotating screws located within the barrel. The screw or screws are typically designed to perform both the pushing and mixing functions, although it is possible that the screw(s) perform only one or the other of these functions, and some other apparatus performs the other. However, the most preferred device is a single- or twin-screw extruder in which the screw or screws include mixing elements.

A twin-screw extruder equipped with a backpressure regulator is an especially preferred apparatus. The backpressure regulator includes a conduit or conduits having a variable cross-section. It operates by adjusting the cross-sectional area of the conduit or conduits such that a predetermined pressure is maintained upstream of the backpressure regulator. Many devices of this type are commercially available, include those sold by Fluid Control Systems, Inc., Spartanburg, S.C. under the tradename GO Regulators. The preferred backpressure regulator can be adjusted to provide a predetermined backpressure and have a high pressure release mechanism which allows excess pressures to be relieved if a predetermined maximum pressure is exceeded.

The method can be carried out batch-wise, continuously or semi-continuously.

In a batch process, the ingredients are conveniently combined in an appropriate vessel, heated under pressure and under shear to heat soften the thermoplastic polymer droplets and shear the droplets to size and then cooled to solidify the particles.

In some embodiments of a continuous or semi-continuous process, the thermoplastic may be combined with one or more of the other ingredients and heat-softened in the presence of such other ingredients. Alternatively, the thermoplastic polymer is heat-softened before being combined with the other ingredients.

In a preferred process, the thermoplastic polymer is heat-softened and mixed with the stabilizer, or a mixture of the dispersion stabilizer and a minor portion of the (component i), followed by adding the resulting mixture to the remaining portion of component i) and the antisolvent, simultaneously or in either order.

In a particular process, the thermoplastic polymer is introduced into a mixing section of an extruder. The thermoplastic polymer may be fed into the extruder as a solid material from a hopper or similar device and then heat-softened in the mixing section of the extruder or in another section upstream of the mixing section. Alternatively, the thermoplastic polymer may be fed into the extruder as a heat-softened material. In the latter case, the heat-softened polymer may be fed into the extruder through an injection port, a hopper or similar feeding apparatus that can handle a viscous fluid. In a particular embodiment, the thermoplastic polymer is heat softened in a first extruder, and the heat-softened polymer is fed into the barrel of a second extruder where it is used to form the polymer polyol.

In the preferred process, the extruder contains at least one injection port within or upstream of a first mixing section, through which the components i), iii) and iv) are introduced into the extruder. Components i), iii) and iv) can be introduced in any order or in any sub-combination, although it is preferred to introduce the dispersion stabilizer (optionally together with a minor amount of component i)) simultaneously with or prior to introducing the major portion of component i), i.e., at the same point or upstream of the point(s) at which the major portion of component i) is introduced. The antisolvent is preferably introduced simultaneously with or after the dispersion stabilizer and before the major portion of component i) is introduced. Components i), iii) and iv) are then mixed with the heat-softened polymer in the mixing section of the extruder. The mixing section of the extruder preferably contains a gear mixer or other mixing elements.

It is often advantageous to use as high a temperature as possible in the first mixing section, consistent with the thermal stability of the various materials, to reduce the viscosity of the heat-softened thermoplastic polymer. Temperature conditions that result in significant degradation of the materials are to be avoided. The necessary temperatures in any given case will of course depend on the particular starting materials that are used. It is usually preferable to avoid using a temperature in excess of 80° C. above the crystalline melting temperature (for a semi-crystalline polymer) or glass transition temperature, whichever is higher, of the thermoplastic polymer. Pressure conditions throughout the process are sufficient to maintain component i) and antisolvent (component iv) as liquids.

It is preferred to preheat the stabilizer (and any component i) that may be present in the stabilizer), before introducing it into the first mixing section, to a temperature at or near the temperature that is desired in the first mixing section. This helps to prevent localized cool spots and to prevent the melted thermoplastic polymer from solidifying locally.

In the preferred process, the resulting mixture of polystyrene polymer, component i), dispersion stabilizer and antisolvent is then conveyed to a downstream section of the extruder, wherein the mixture is subjected to shear conditions to break the heat-softened thermoplastic polymer into droplets dispersed in component i). “Conveyed” in this context means simply that the mixture is moved downstream in the extruder to a zone where the second mixing step is performed. This is typically performed through the normal operation of the extruder screw or screws, which move the material forward through the extruder in plug flow fashion.

The temperature and pressure conditions in the downstream section are in general as described with respect to the first mixing section. The temperatures and pressures are not necessarily identical to those in the preceding section of the extruder, but they maybe.

After the heat-softened thermoplastic polymer has been dispersed into component i), the resulting polymer polyol is cooled enough to solidify the dispersed polystyrene polymer droplets to form particles. The polymer polyol should be agitated until the particles have solidified to prevent agglomeration and/or fouling of equipment. The size of the resulting particles will be very close to that of the droplets before they are cooled, although there may be some small differences due to thermal expansion or contraction or due to a phase change in the case of a crystalline or semi-crystalline polymer. The cooling step can be performed within the extruder or after the polymer polyol is discharged from the extruder. If the polymer polyol is cooled within the extruder, it is preferred to cool it before it reaches any region of restricted flow defined by the backpressure regulator. This can reduce or prevent fouling of the equipment in that region of the apparatus, and prevent or reduce particle agglomeration from occurring there. Alternatively, the cooling can be done after the polymer polyol is discharged from the extruder, such as passing it through a co- or counter-flow heat exchanger. It is also possible to cool the polymer polyol in a mixing vessel operated at a low temperature in order to quench the discharge from the extruder.

The polymer polyol so produced may be treated to remove volatiles (including the antisolvent) and other impurities. Some or all of the antisolvent may flash upon release of the pressure from the apparatus or when the product exits an extruder. If the stabilizer contained a solvent that was not previously removed, the solvent can be removed from the polymer polyol product at this stage. Volatiles can be removed by subjecting the polymer polyol to heat and/or a reduced pressure, using a suitable device such as a rotary evaporator or a wiped film evaporator. Temperatures should not be so high as to melt or soften the dispersed particles of the polystyrene polymer.

It is also possible to devolatilize the polymer polyol in a decompression zone of the extruder, before or after the cooling step.

The antisolvent preferably is removed to a level of no greater than 0.1% by weight, based on the total weight of the polymer polyol.

The proportions of components i), ii) and iii) in the polymer polyol product generally corresponds to the proportions of those components used in the manufacturing process. In particular, the polymer polyol may contain at least 5 wt.-%, at least 10 wt.-%, at least 25 wt.% and up to 50 wt.%, up to 40 wt.-% or up to 35 wt.-% the thermoplastic polymer. In some embodiments, the polymer polyol may contain at least 30 wt.-% and up to 50 wt.-% of one or more polymerized vinyl monomers, the polymerized vinyl monomers being derived from components ii) and iii). In particular embodiments, the polymer polyol contains 30 to 50 wt.-% polymerized styrene or polymerized styrene and acrylonitrile. The amounts of polymerized vinyl monomers such as styrene and/or acrylonitrile in the polymer polyol product can be measured using NMR methods.

The polymer polyol is useful to make a wide variety of polyurethane and/or polyurea products. The polyurethane and/or polyurea products will be in most instances elastomeric materials that may be non-cellular, microcellular or foamed. Polyurethanes are typically prepared by reacting the polymer polyol with a polyisocyanate. The polymer polyol product may be blended with one or more additional polyols, including those types described above, to adjust the solids content to a desired level or provide particular characteristics to the polyurethane. The reaction with the polyisocyanate is performed in the presence of a blowing agent or gas when a cellular product is desired. The reaction may be performed in a closed mold, but in some applications, such as slabstock foam, the reaction mixture is generally permitted to rise more or less freely to form a low density foam material. Generally, the polymer polyol of the invention can be used in the same manner as conventional polymer polyol materials, using the same general types of processes as are used with the conventional materials.

Suitable polyisocyanates include aromatic, cycloaliphatic and aliphatic isocyanate. Exemplary polyisocyanates include m-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotolylene diisocyanate, naphthylene-1,5-diisocyanate, 1,3- and/or 1,4-bis(isocyanatomethyl)cyclohexane (including cis- and/or trans isomers) methoxyphenyl-2,4-diisocyanate, dip henylmethane-4,4′-diisocyanate, diphenylmethane-2,4′-diisocyanate, hydrogenated diphenylmethane-4,4′-diisocyanate, hydrogenated diphenylmethane-2,4′-diisocyanate, 4,4′-biphenylene diisocyanate, 3,3′-dimethoxy-4,4′-biphenyl diisocyanate, 3,3′-dimethyl- 4-4′-biphenyl diisocyanate, 3,3′-dimethyldiphenyl methane-4,4′- diisocyanate, 4,4′,4″-trip henyl methane triisocyanate, a polymethylene polyphenylisocyanate (PMDI), toluene-2,4,6-triisocyanate and 4,4′ -dimethyldip henylmethane-2,2′,5,5′-tetraisocyanate. Preferably the polyisocyanate is diphenylmethane-4,4′-diisocyanate, diphenylmethane-2,4′-diisocyanate, PMDI, toluene-2,4-diisocyanate, toluene-2,6-diisocyanate or mixtures thereof. Diphenylmethane-4,4′-diisocyanate, diphenylmethane-2,4′-diisocyanate and mixtures thereof are generically referred to as MDI, and all can be used. Toluene-2,4-diisocyanate, toluene-2,6-diisocyanate and mixtures thereof are generically referred to as TDI, and all can be used.

The amount of polyisocyanate used in making a polyurethane is commonly expressed in terms of isocyanate index, i.e., 100 times the ratio of NCO groups to isocyanate-reactive groups in the reaction mixture (including those provided by water if used as a blowing agent). In the production of conventional slabstock foam, the isocyanate index typically ranges from about 95 to 140, especially from about 105 to 115. In molded and high resiliency slabstock foam, the isocyanate index typically ranges from about 50 to about 150, especially from about 85 to about 110.

A catalyst is often used to promote the polyurethane-forming reaction. The selection of a particular catalyst package may vary somewhat with the particular application, the particular polymer polyol or dispersion that is used, and the other ingredients in the formulation. The catalyst may catalyze the “gelling” reaction between the polyol(s) and the polyisocyanate and/or, in many polyurethane foam formulation(s), the water/polyisocyanate (blowing) reaction which generates urea linkages and free carbon dioxide to expand the foam. In making water-blown foams, it is typical to use a mixture of at least one catalyst that favors the blowing reaction and at least one other that favors the gelling reaction.

A wide variety of materials are known to catalyze polyurethane-forming reactions, including tertiary amines, tertiary phosphines, various metal chelates, acid metal salts, strong bases, various metal alcoholates and phenolates and metal salts of organic acids. Catalysts of most importance are tertiary amine catalysts and tin catalysts. Examples of tertiary amine catalysts include trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts are often used. Examples of tin catalysts are stannic chloride, stannous chloride, stannous octoate, stannous oleate, dimethyltin dilaurate, dibutyltin dilaurate, other tin compounds of the formula SnRₙ(OR)₄₋ₙ, wherein R is alkyl or aryl and n is 0-2, and the like. Tin catalysts are generally used in conjunction with one or more tertiary amine catalysts, if used at all. Tin catalysts tend to be strong gelling catalysts, so they are preferably used in small amounts, especially in high resiliency foam formulations. Commercially available tin catalysts of interest include Dabco™ T-9 and T-95 catalysts (both stannous octoate compositions available from Air Products and Chemicals).

Catalysts are typically used in small amounts, for example, each catalyst being employed from about 0.0015 to about 5% by weight of the high equivalent weight polyol.

When forming a foam, the reaction of the polyisocyanate and the polyol component is conducted in the presence of a blowing agent. Suitable blowing agents include physical blowing agents such as various low-boiling chlorofluorocarbons, fluorocarbons, hydrocarbons and the like. Fluorocarbons and hydrocarbons having low or zero global warming and ozone-depletion potentials are preferred among the physical blowing agents. Chemical blowing agents that decompose or react under the conditions of the polyurethane-forming reaction are also useful. By far the most preferred chemical blowing agent is water, which reacts with isocyanate groups to liberate carbon dioxide and form urea linkages. Water is preferably used as the sole blowing agent, in which case about 1 to about 7, especially from about 2.5 to about 5, parts by weight water are typically used per 100 parts by weight high equivalent weight polyol. Water may also be used in combination with a physical blowing agent, particularly a fluorocarbon or hydrocarbon blowing agent. In addition, a gas such as carbon dioxide, air, nitrogen or argon may be used as the blowing agent in a frothing process. Carbon dioxide can also be used as a liquid or as a supercritical fluid.

A foam-stabilizing surfactant is also used when a polyurethane foam is prepared. A wide variety of silicone surfactants as are commonly used in making polyurethane foams can be used in making the foams with the polymer polyols or dispersions of this invention. Examples of such silicone surfactants are commercially available under the tradenames Tegostab™ (Evonik Industries), Niax™ (Momentive Performance Materials) and Dabco™ (Evonik Industries).

In addition to the foregoing components, the polyurethane formulation may contain various other optional ingredients such as cell openers; fillers such as calcium carbonate; pigments and/or colorants such as titanium dioxide, iron oxide, chromium oxide, azo/diazo dyes, phthalocyanines, dioxazines and carbon black; reinforcing agents such as fiber glass, carbon fibers, flaked glass, mica, talc and the like; biocides; preservatives; antioxidants; flame retardants; and the like.

In general, a polyurethane foam is prepared by mixing the polyisocyanate and polymer polyol in the presence of the blowing agent, surfactant, catalyst(s) and other optional ingredients as desired, under conditions such that the polyisocyanate and polyol react to form a polyurethane and/or polyurea polymer while the blowing agent generates a gas that expands the reacting mixture. The foam may be formed by the so-called prepolymer method (as described in U.S. Pat. No. 4,390,645, for example), in which a stoichiometric excess of the polyisocyanate is first reacted with the high equivalent weight polyol(s) to form a prepolymer, which is in a second step reacted with a chain extender and/or water to form the desired foam. Frothing methods (as described in U.S. Pat. Nos. 3,755,212; 3,849,156 and 3,821,130, for example), are also suitable. So-called one-shot methods (such as described in U.S. Pat. No. 2,866,744) are preferred. In such one-shot methods, the polyisocyanate and all polyisocyanate-reactive components are simultaneously brought together and caused to react. Three widely used one-shot methods which are suitable for use in this invention include slabstock foam processes, high resiliency slabstock foam processes, and molded foam methods.

The following examples are provided to illustrate the invention, but are not intended to limit the scope thereof. All parts and percentages are by weight unless otherwise indicated.

### EXAMPLES 1-2 AND COMPARATIVE EXPERIMENTS A AND B

### A. Production of Macromer

Potassium hydroxide is added to a sorbitol-initiated poly(propylene oxide) starter polyol having a weight average molecular weight of about 700. Enough of the potassium hydroxide is added to provide about 2100 ppm KOH in the final product. An 88/12 mixture of propylene oxide and ethylene oxide is added and allowed to polymerize at a temperature of 105° C. to produce a hexafunctional polyol in which propylene oxide and ethylene oxide are randomly polymerized. The final ratio of propylene oxide and ethylene oxide is about 88.5:11.5 by weight. The final hydroxyl number is about 28, which corresponds to a hydroxyl equivalent weight of 2003 and a number average molecular weight of about 12,000. The oxyalkylene content is about 98.4% as calculated from the starting materials. After finishing and addition of 250 ppm antioxidant, 500 parts of this copolymer are heated to 55° C. with stirring and 0.55 moles of TMI (per mole of copolymer) are added. Then 0.05 of a tin catalyst are added, and the mixture is stirred at 55° C. for 120 minutes. The product (Macromer Mixture A) of this reaction is a mixture containing about 55% by weight of a macromer corresponding to the reaction product of TMI and the polyether and about 45% by weight of uncapped polyether. The macromer molecules contain 1-2 polymerizable carbon-carbon double bonds per molecule and 4-5 hydroxyl groups per molecule.

### B. Preparation of Stabilizer Mixture

120 parts of Macromer Mixture A are charged to a reactor equipped with a pump inlet and a stirrer. The headspace is purged several times with nitrogen and padded with nitrogen. The reactor is sealed and it and its contents are heated to 120° C. With agitation and while keeping the reaction temperature at 120° C., there is added over 2 hours a mixture of 160 parts by weight styrene, 0.96 parts of a free radical initiator and 519 parts of a Polyol A (a 4600 molecular weight, 36 hydroxyl number polyol made by adding propylene oxide and then 20.3% based on total polyol weight of ethylene oxide onto glycerin). After this mixture is added, agitation is maintained as the temperature is increased to 150° C. over three hours, followed by holding that temperature for 1 hour and then cooling to 40° C. The resulting Stabilizer Mixture contains about 28% by weight of a copolymer of styrene and the macromer formed in step A (the dispersion stabilizer) and 72% by weight of polyether polyols (Polyol A plus the amount of uncapped polyether from step A). The Stabilizer Mixture contains about 20% polymerized styrene.

### C. Preparation of Polymer Polyols

Comparative Sample A: 28 parts of the Stabilizer Mixture from step B, 35 parts of a polystyrene having a Vicat softening temperature of about 103° C. and a number average molecular weight of 40,000 g/mol, and 37 parts of Polyol A are loaded into a Parr reactor equipped with a Cowles blade. The reactor is closed and pressurized to 400 psig (2.75 MPa). The reactor contents are heated to 220° C. and held at that temperature for 20 minutes, and then cooled to room temperature, with constant agitation. The Cowles blade is rotated at a speed of 60 rpm until the temperature reaches 180° C., at 500 rpm when until the temperature reaches 220° C., at 1000 rpm until the temperature returns to 180° C., at 500 rpm until the temperature returns to 100° C. and thereafter at 60 rpm. The higher agitation rates are sufficient to shear the mixture to form a dispersion of polystyrene particles in Polyol A.

The resulting polymer polyol contains 35% by weight of the polystyrene, about 7.84% by weight of the dispersion stabilizer and the remainder polyether polyols (Polyol A plus uncapped polyether from step A above). The dispersed polystyrene particles have a volume average particle size of 13.6 μm (as measured with a BeckmanCoulter Micro Liquid Module laser diffraction particle size measurement instrument after diluting the sample with isopropanol). The polymer polyol has a Brookfield viscosity (20 rpm, #4 spindle, 25° C.) of 6180 mPa·s.

Example 1: Comparative Sample A is repeated, adding 5 parts of water into the Parr reactor prior to closing the reactor and heating its contents. The pressure conditions are sufficient to maintain the water in liquid form throughout the process. Water is removed from the product via rotary evaporation until the water content is reduced to less than 0.05% by weight, based on total product weight. The dispersed particles in the resulting polymer polyol has a volume average particle size of 5.8 μm. The polymer polyol has a Brookfield viscosity of 3480 mPa·s. The addition of water into the mechanical dispersion process results in a decrease in both particle size and product viscosity.

Comparative Sample B: Polystyrene as described in previous examples is fed at a rate of 35 parts per hour into the inlet end of a twin-screw extruder having a L/D ratio of 60 and multiple heating zones. The temperatures in the heating zones increase from 30° C. to 200° C. Screw speed is 1000 rpm. The screw is equipped with gear mixer elements to facilitate mixing of the high viscosity heat-softened polystyrene into the much lower viscosity Polyol A. In a downstream section, at which the polystyrene has become heat-softened, 28 parts per hour of the Stabilizer Mixture from Step B and 35 parts per hour of Polyol A are added through separate injection ports. Pressure in the extruder is maintained at 650 psig (4.5 MPa). The heat-softened polystyrene is sheared into small droplets that become dispersed in Polyol A, which forms a continuous phase. The resulting dispersion is collected from the outlet end of the extruder and cooled to room temperature in a stirred vessel. It contains 35% by weight of the polystyrene, about 7.84% by weight of the dispersion stabilizer and the remainder polyether polyols (Polyol A plus uncapped polyether from step A above). The dispersed particles have a volume average particle size of 4.0 μm (as measured with a BeckmanCoulter Micro Liquid Module particle size measurement instrument after diluting the sample with isopropanol). The dispersion has a Brookfield viscosity of 7400 mPa·s. This continuous extrusion process produces a smaller particle size product than the batch process of Comparative Sample A, but the product viscosity is significantly higher.

Example 2: Comparative Sample B is repeated, adding 5 parts per hour of water. The water is injected through the same injection port as the Stabilizer Mixture from Step B. The pressure conditions within the extruder are sufficient to maintain the water in liquid form. After the extruded product has cooled to room temperature, water is removed using a rotary evaporator until the water content of the product is less than 0.05% by weight. The resulting polymer polyol has a volume average particle size of 3.4 μm (as measured with a BeckmanCoulter Micro Liquid Module particle size measurement instrument after diluting the sample with isopropanol), and a Brookfield viscosity (of 6400 mPa·s.

Compared with Comparative Sample B, the addition of the water results in a significant reduction in particle size and in product viscosity.

1. A method for making a polymer polyol, comprising the steps of:
(a) forming a heated and pressurized mixture of i) one or more 250 to 6000 hydroxyl equivalent weight alcohols selected from the group consisting of polyethers having an an oxyalkylene content of at least 80% by weight, polyesters and natural oil polyols, each 250 to 6000 hydroxyl equivalent weight alcohol nominally having 1 to 8 hydroxyl groups per molecule, wherein each such 250 to 6000 hydroxyl equivalent weight alcohol is a liquid at 25° C. and 101.3 kPa atmospheric pressure and has a boiling temperature of at least 150° C. at 101.3 kPa atmospheric pressure; ii) a thermoplastic polymer that is insoluble in component i) and has a Vicat softening temperature of greater than 60° C. and up to 300° C.; iii) a dispersion stabilizer and iv) an antisolvent, the heated and pressurized mixture being at a temperature above the Vicat softening temperature of the thermoplastic polymer and at a pressure sufficient to maintain the antisolvent and component i) as a liquid,
(b) shearing the heated and pressurized mixture to form a dispersion of droplets of the heat-softened thermoplastic polymer in a liquid phase that includes the 250 to 6000 hydroxyl equivalent weight alcohol or alcohols and
(c) cooling the dispersion of droplets to below the Vicat softening temperature of the thermoplastic polymer to solidify the droplets of the thermoplastic polymer to form particles thereof and form the polymer polyol.

2. The method of claim 1 wherein the mixture formed in step (a) comprises 30 to 75 weight-% of i), 20 to 55 weight-% of ii), 0.5 to 5 weight-% of iii) and 2 to 10 weight-% of iv), the weight percentages being based on the combined weights of i), ii), iii) and iv).

3. The method of claim 1 further comprising (d) simultaneously with and/or after step (c), removing antisolvent from the polymer polyol until the antisolvent content of the polymer polyol is less than 0.5% by weight.

4. The method of claim 3 wherein after step (d) the polymer polyol contains 35 to 55% by weight of dispersed particles of the thermoplastic polymer.

5. The method of claim 1, wherein the stabilizer includes a copolymer of (1) from 10 to 40% by weight of a branched polyol having a molecular weight of from 4000 to 20,000, at least one polymerizable ethylenically unsaturated group per molecule and from about 3 to about 8 hydroxyl groups per molecule with (2) from 60 to 90% by weight of styrene or a mixture of styrene and one or more other low molecular weight monomers.

6. The method of claim 1 wherein the antisolvent includes water.

7. The method of claim 1 wherein component i) is one or more polyether polyols.

8. The method of claim 1 wherein component ii) is polystyrene or a styrene-acrylonitrile copolymer.

9. A polymer polyol made in accordance with claim 1.
